(19) United States
(12) Patent Application Publication
(10) Pub. No.: US 2011/0004350 A1
(43) Pub. Date: Jan. 6, 2011

(54) RENEWABLE THERMAL ENERGY METERING AND CONTROLS SYSTEM

(75) Inventors: Daniel CHEIFETZ, Deerfield, IL (US); Erik Larson, Evanston, IL (US); Benjamin Heymer, Chicago, IL (US); Robert Olden, Chicago, IL (US); Andrew Cronk, Chicago, IL (US)

Correspondence Address: VENABLE LLP, P.O. BOX 34385, WASHINGTON, DC, 20043-9998, US

(73) Assignee: Indie Energy Systems Company, Evanston, IL (US)

(21) Appl. No.: 12/828,863

(22) Filed: Jul. 1, 2010

Related U.S. Application Data
(60) Provisional application No. 61/222,337, filed on Jul. 1, 2009.

(51) Int. Cl. G08C 19/00; G05D 23/19

(52) U.S. Cl. 700/276; 340/870.02

(57) ABSTRACT

A system and method for metering and controlling a renewable energy HVAC system. The system and method includes the steps of: receiving a measured value of a parameter of a renewable energy HVAC system at a central computer; determining an energy usage of the renewable energy HVAC system with the central computer based on the measured value; and estimating an energy usage of a simulated conventional HVAC system with the central computer based on the measured value. The system and method includes determining an energy savings of the renewable energy HVAC system with the central computer by comparing the determined energy usage to the estimated energy usage of the simulated conventional HVAC system. The system and method further includes transmitting the energy savings to a receiving device.

### CROSS REFERENCE TO RELATED APPLICATION

This application claims the priority of U.S. Provisional Application No. 61/222,337, filed on Jul. 1, 2009, which is incorporated herein by reference.

### BACKGROUND

HVAC monitoring and control systems are generally known in the art. For example, companies such as Johnson Controls Inc., Trane®, and Automated Logic® Corporation provide building automation and direct digital control systems that utilize the Internet for remote viewing and control purposes. However, these known approaches do not analyze and verify the performance of renewable thermal energy systems, for example geothermal-heat-exchange, solar thermal, and other thermal energy HVAC systems, based on a comparison to a simulated equivalent conventional HVAC system. Neither do these known approaches store system data into a remote and central data repository for storage and analysis using the Internet. Rather, these prior approaches are primarily used for basic building automation and control. Additionally, known systems often require advanced knowledge of building automation and control systems for use and, thus, are not adapted for use by the average building- or home-owner or other unskilled persons.

Similarly, the “Web Energy Logger” by OurCoolHouse.com provides a system for metering renewable energy HVAC systems, but does not compare the performance of the renewable energy HVAC system with the expected performance of an equivalent conventional HVAC system. Nor does the “Web Energy Logger” allow a remote user to control the renewable energy HVAC system remotely.

### SUMMARY

An object of the invention is to produce an easy-to-use metering and controls system, whereby third-party users, including building managers, tenants and potential customers, are able to view, understand and control the performance and value of their renewable thermal energy HVAC system.

The present invention relates generally to methods and devices for remotely controlling and metering the energy usage of a renewable energy heating, ventilation and air conditioning (HVAC) system or industrial heat transfer system, such as a geothermal heat exchange system, comparing the energy usage to a simulated conventional thermal system, and communicating the energy savings (or correlated cost or carbon savings) in real time over a network to a remote user.

One embodiment of the invention relates to a method for metering a renewable energy HVAC system, including the steps of: receiving a measured value of a parameter of a renewable energy HVAC system at a central computer; determining an energy usage of the renewable energy HVAC system with the central computer based on the measured value; estimating an energy usage of a simulated conventional HVAC system with the central computer based on the measured value; determining an energy savings of the renewable energy HVAC system with the central computer by comparing the determined energy usage of the renewable energy HVAC system to the estimated energy usage of the simulated conventional HVAC system; and transmitting the energy savings to a receiving device. For the purposes of this application, the step of determining an energy usage of the renewable energy HVAC system may include both determining the actual energy usage of the system and estimating the energy usage of the system based on the measured value. Additionally, for the purposes of this application, the step of estimating an energy usage of the simulated conventional HVAC system may include calculating or recalling data from a look-up or reference table.

A further embodiment of the invention relates to a non-transitory computer readable medium storing computer readable program code for causing a computer to perform the steps of: receiving a measured value of a parameter of a renewable energy HVAC system; determining an energy usage of the renewable energy HVAC system based on the measured value; estimating an energy usage of a simulated conventional HVAC system based on the measured value; and determining an energy savings of the renewable energy HVAC system by comparing the determined energy usage of the renewable energy HVAC system to the estimated energy usage of the simulated conventional HVAC system.

Another embodiment of the invention relates to a central renewable energy HVAC metering and control system, including: a central receiver to receive a measured value of a parameter of a renewable energy HVAC system; a first processing device configured to receive the measured value from the receiving device and to determine an energy usage of the renewable energy HVAC system based on the measured value and to estimate an energy usage of a conventional HVAC system based on the measured value; a second processing device coupled to the first processing device to calculate an energy savings of the renewable energy HVAC system by comparing the determined energy usage of the renewable energy HVAC system to the estimated energy usage of the simulated conventional HVAC system; and a transmitting device configured to receive the energy savings from the second processing device and to transmit the energy savings to a receiving device. For the purposes of this application, the first and second processing devices, as well as any other processing devices, may be separate devices or may be part a single computer able to run different programs.

According to one embodiment, a method for metering and controlling a renewable energy HVAC system includes the steps of: metering a parameter of a renewable energy HVAC system at a computer; transmitting a measured value of the parameter to a receiving device; receiving a control signal from the receiving device at the computer; and adjusting an operational mode of the renewable energy HVAC system with the computer based on the control signal to change an energy savings of the renewable energy HVAC system.

According to another embodiment, a non-transitory computer readable medium storing computer readable program code for causing a computer to perform the steps of: metering a parameter of a renewable energy HVAC system; receiving a control signal from a receiving device; and adjusting an operational mode of the renewable energy HVAC system based on the control signal to change an energy savings of the renewable energy HVAC system.

According to a further embodiment, a renewable energy HVAC metering and control system includes: a metering device to monitor a parameter of a renewable energy HVAC system; a transmitting device coupled to the metering device and configured to transmit a measured value of the parameter to a centralized controller over a network; a receiving device to receive a control signal from a remote device; and an adjusting device coupled to the receiving device to adjust an operational mode of the renewable energy HVAC system based on the control signal to change an energy savings of the renewable energy HVAC system.

This summary is provided merely to introduce certain concepts and not to identify any key or essential features of the claimed subject matter. Further features and advantages of embodiments of the invention, as well as the structure and operation of various embodiments of the invention, are described in detail below with reference to the accompanying drawings.

### BRIEF DESCRIPTION OF THE DRAWINGS

The foregoing and other features and advantages of embodiments of the invention will be apparent from the following, more particular description of embodiments of the invention, as illustrated in the accompanying drawings wherein like reference numbers generally indicate identical, functionally similar, and/or structurally similar elements. Unless otherwise indicated, the accompanying drawing figures are not to scale.

FIG. 1 depicts a general schematic of the renewable thermal energy HVAC metering and control system according to an embodiment of the present invention;

FIG. 2A depicts an energy load schematic of an actual building with a renewable thermal energy HVAC system, according to an embodiment of the present invention;

FIG. 2B depicts an energy load schematic of an equivalent simulated building with a conventional HVAC system, according to an embodiment of the present invention;

FIG. 3 depicts a performance comparison chart between a renewable thermal energy HVAC system and a conventional HVAC system using algorithms or tables, according to one embodiment of the present invention.

FIG. 4A depicts a renewable energy HVAC system metering and control diagram, according to an embodiment of the present invention;

FIG. 4B depicts a renewable energy HVAC system metering and control diagram utilizing third-party control, according to a different embodiment of the present invention;

FIG. 5 depicts an exemplary “dashboard” screen of the renewable energy HVAC metering and control website accessible by a user over the Internet, according to an embodiment of the present invention;

FIG. 6 depicts a “sites” screen of the renewable energy HVAC metering and control website accessible by a user over the Internet, according to an embodiment of the present invention;

FIG. 7 depicts an “instrument panel” screen of the renewable energy HVAC metering and control website accessible by a user over the Internet, according to an embodiment of the present invention;

FIG. 8 depicts a “system performance” screen of the renewable energy HVAC metering and control website accessible by a user over the Internet, according to an embodiment of the present invention;

FIGS. 9A-9D depict “savings report” screens of the renewable energy HVAC metering and control website accessible by a user over the Internet, according to an embodiment of the present invention;

FIGS. 10A-10B depict “CO₂ emissions environmental benefits report” screens of the renewable energy HVAC metering and control website accessible by a user over the Internet, according to an embodiment of the present invention;

FIGS. 11A-11B depict “tree equivalent environmental benefits report” screens of the renewable energy HVAC metering and control website accessible by a user over the Internet, according to an embodiment of the present invention;

FIGS. 12A-12B depict “transportation equivalent environmental benefits report” screens of the renewable energy HVAC metering and control website accessible by a user over the Internet, according to an embodiment of the present invention; and

FIG. 13 depicts a hand-held Internet-enabled device for viewing renewable energy HVAC metering and control system-related information, according to one embodiment of the present invention.

### DETAILED DESCRIPTION

Various embodiments of the invention are discussed herein. Where specific embodiments are discussed, specific terminology is employed for the sake of clarity. However, the invention is not intended to be limited to the specific terminology so selected and it should be understood that this is done for illustration purposes only. A person skilled in the relevant art will recognize that other components and configurations can be used without parting from the spirit and scope of the invention. Each specific element includes all technical equivalents that operate in a similar manner to accomplish a similar purpose. For the purposes of this invention, the term “HVAC” may be interchangeable with any descriptor for a mechanical system or method that controls temperatures or manages thermal interactions within a building or within any industrial process. All publications cited in this application are incorporated herein by reference.

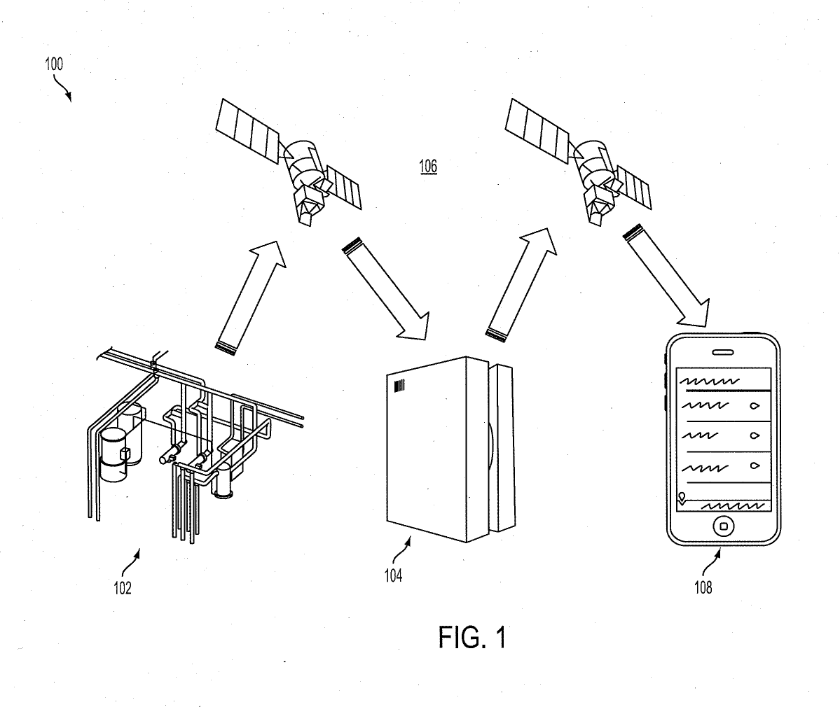

Referring now to the drawings, there is shown in FIG. 1 a general schematic of the renewable energy HVAC metering and control system 100 according to an embodiment of the present invention. “Metering” refers to the measurement or determination of energy consumption and/or the measurement of values that can be correlated to energy consumption, for example, the measurement of temperature or the reduction of CO₂. “Control” or “controlling” refers to the execution of logical sequences and/or adjustment of the logical values that define logical sequences to modify the performance of the renewable energy HVAC system.

In order to facilitate the transmission and calculation of system performance, sensors 102 are installed at various locations throughout the renewable energy HVAC system and are used to monitor or meter certain system parameters. The term “system parameters” refers to constant or variable terms of the renewable energy HVAC system, such as, for example, temperature, pressure, flow rate, utility consumption, etc. The sensors 102 may be compatible with communications and network control devices. The sensors 102 may receive and/or transmit a signal correlated with a measured value of one or more system parameters. According to one embodiment, analog signals from the sensors 102 may be converted into digital signals and sent to a web server device that is connected to the Internet 106, by an Internet router, modem, etc. The information may then be transmitted over the Internet network 106 to a remote central computer 104 that processes information. The processed information may then be transmitted over the Internet network 106 to a web device 108, for example a Blackberry®, an IPhone®, IPad®, personal computer or laptop, or other remotely accessed device, to be viewed by a remote user. By use of the term “Internet,” it should be understood that the foregoing is not intended to limit the present invention to a network, also known as the World Wide Web. It includes intranets, extranets, Virtual Private Networks (VPNs), Local Area Networks (LANs), Wide Area Networks (WANs), and the like.

For the purposes of this application a “conventional HVAC system” refers to a HVAC system that uses a non-renewable resource as the energy source and/or a HVAC system that uses a heat sink/source, such as ambient outside air, that is less-efficient than a comparable renewable heat sink/source, such as a geothermal heat exchanger. A non-renewable resource refers to a natural resource which cannot be produced, grown, generated, or used on a scale which can sustain its consumption rate. These resources often exist in a fixed amount, or are consumed much faster than nature can create them. Fossil fuels (such as coal, oil, petroleum and natural gas), electricity and nuclear power (uranium) are examples.

“Renewable energy” refers to energy derived from natural resources, such as sunlight, wind, rain, geothermal or ground source heat exchange, etc., that may be naturally replenished. According to one embodiment, the renewable energy HVAC metering and controls system 100 may be a geothermal energy system including a geothermal heat exchanger. According to this embodiment, one or more sensors 102 may be installed to measure different parameters, for example, the temperature change and/or pressure change across the geothermal heat exchanger, the flow rate through the geothermal heat exchanger, utility consumption and/or mechanical ventilation and exhaust.

According to one embodiment, the renewable energy HVAC metering and control system 100 may provide substantially real-time metering and controls for energy savings validation, carbon credit aggregation, and system control of any renewable energy HVAC system. The renewable energy HVAC metering and control system 100 may provide metered information to a virtual utility tool for assessing and billing for energy use. The renewable energy HVAC metering and control system 100 may allow for third party control and/or validation of system performance through information transmitted via the Internet or other means of electronic communication to an Internet-connected building automation system installed in the building. Additionally, the renewable energy HVAC metering and control system 100 may allow control through a third-party mobile device for remote access.

According to another embodiment, the renewable energy HVAC metering and control system 100 may provide substantially real-time metering of the performance and energy use of renewable energy HVAC systems, including geothermal heat exchange HVAC and other thermal energy HVAC systems. This real-time metering may include a quantitative evaluation of the useful variable outputs of a system compared to the input cost. The renewable energy HVAC metering and control system 100 may be used on renewable energy systems in public, commercial, industrial, health care, residential and other buildings.

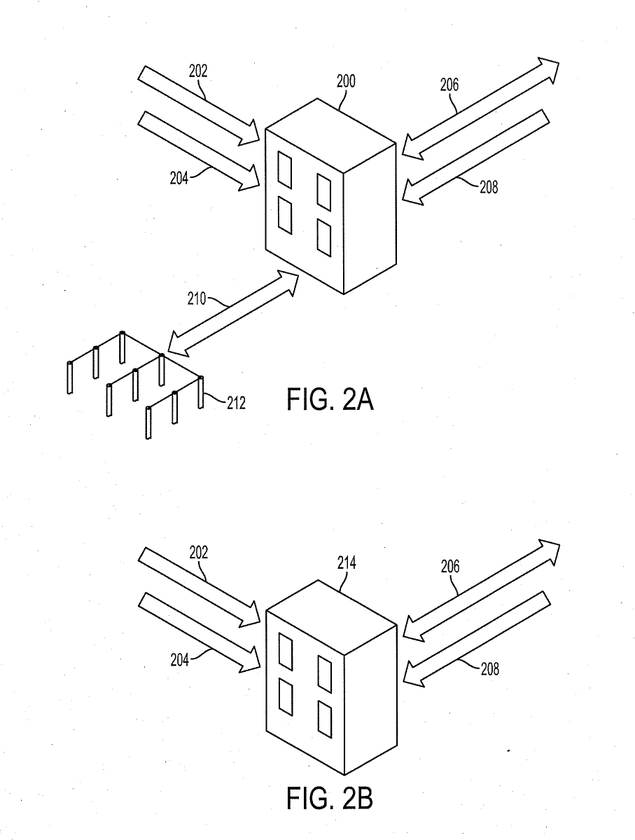

FIG. 2A depicts an energy load schematic of an actual building 200 with a renewable energy HVAC system, according to an embodiment of the present invention. The actual building 200 is shown to receive the following energy inputs: electrical energy 202, fuel energy 204 and biological gains 208. Biological gains may include heat or humidity produced by humans or other animals such as livestock or pets or plants. The actual building 200 similarly emits and receives energy 206 to and from the environment and renewable energy 210 to and from a renewable energy source 212, such as a geothermal closed loop well system.

FIG. 2B depicts an energy load schematic of an equivalent simulated building 214 with a conventional HVAC system, according to an embodiment of the present invention. Similar to the actual building 200 in FIG. 2A, the simulated building 214 receives electrical energy 202, fuel energy 204 and biological gains 208. The simulated building 214 further emits and receives energy 206 to and from the environment. However, the simulated building does not emit and receive renewable energy 210 to and from a renewable energy source 212.

The act of “comparing” or “comparison” refers to examining the difference between the expected or actual energy costs (both economic and environmental) of a functioning renewable energy HVAC system with the expected costs of an equivalent conventional HVAC system. “Equivalent” means a building with similar, if not identical, heating and cooling loads, with heating and cooling provided by conventional means, for example, electric, natural gas, oil, or otherwise. According to one embodiment, the expected or measured electrical energy 202 usage and fuel energy 204 usage of actual building 200 in FIG. 2A having a renewable energy HVAC system may be compared to the expected electrical energy 202 usage and fuel energy 204 usage of the simulated building 214 in FIG. 2B having a simulated conventional HVAC system to calculate the energy savings of the renewable energy HVAC system. Such a comparison may be accomplished in real-time. The actual measured or estimated energy usage of the renewable energy HVAC system may be determined based on a measured value of at least one system parameter of the renewable energy HVAC system. The expected performance of both the renewable and conventional system alternatives may be calculated from real metered energy usage and/or other metered parameters identified to be exemplary of energy use. Comparison calculations may include algorithms and/or reference tables derived from previous computer simulations of the actual system and/or the equivalent conventional system. The algorithms and reference tables may have one or multiple dimensions that correspond to real parameters metered within the renewable energy HVAC system.

In an exemplary embodiment, the renewable energy HVAC metering and control system 100 is implemented in conjunction with a geothermal HVAC system as part of either a retrofit or new construction of a building. Alternatively, the renewable energy HVAC metering and control system 100 could be added to an existing geothermal heat exchange energy HVAC system. The attributes of the actual building 200 and the renewable energy HVAC system are modeled in a computer simulation environment, using commercially available software such as the Transient Energy System Simulation Tool (TRNSYS). The computer simulation environment may allow software users to access relevant variables and computer code used in the simulation. The computer simulation environment may also allow for the creation of an equivalent conventional HVAC system alternative, i.e. a “baseline” or “comparison” system, that offers a representation of how the building would perform if it had been instead constructed to use conventional energy resources. The “baseline” or “comparison” system is a simulated conventional HVAC system for a hypothetical building having similar, if not identical, building attributes and cooling and heating characteristics as the actual building being serviced by the renewable energy HVAC system. The simulated conventional HVAC system may use non-renewable resources, such as electricity, natural gas or oil, as is commonly used in the art.

According to one embodiment, the computer simulation environment may include a building geometry module which simulates or models the heat transfer between one or more zones and the outside environment. The building geometry module may also contain dynamic information about thermal gains, occupant loads, humidity and ventilation. A spreadsheet tool may be used to store information that is entered into the building model.

According to another embodiment, the computer simulation environment may include a weather data reader, which may take real weather information from an external file and deliver it to the computer simulation environment for determination of an estimated or measured energy usage.

The computer simulation results may be used to identify exemplary system parameters and may be used to derive one-dimensional or multi-dimensional algorithms and/or reference tables that take real metered parameters as inputs and output expected energy consumption and other performance parameters. These algorithms/tables may be created for both the renewable energy HVAC system, for example a geothermal-heat-exchange-based system, and the conventional HVAC system such that an energy savings comparison can be generated from the actually-functioning geothermal-heat-exchange-based system's real metered variables, such as temperature, pressure, and flow rate, among others. Additionally, actual energy consumption may be metered and, after some period of time, may be used to calibrate and improve the accuracy of algorithms/tables that are used to generate performance comparisons.

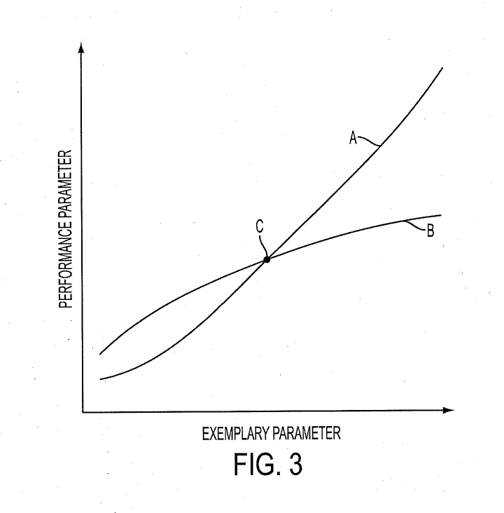

For example, FIG. 3 depicts a performance comparison chart between a renewable energy HVAC system and a conventional HVAC system using algorithms or tables, according to one embodiment of the present invention. The chart embodied in FIG. 3 is an example of a one-dimensional algorithm, wherein the y-axis denotes a performance parameter, for example energy usage, and the x-axis denotes an exemplary parameter, for example geothermal heat transfer power. Line A represents a conventional energy resource relationship, whereas line B represents a renewable energy resource relationship. The chart indicates that a renewable energy resource relationship enables a more efficient performance parameter, i.e. energy usage, after a certain exemplary parameter, i.e. geothermal heat transfer power, is reached (See point C). For any exemplary parameter value, or set of parameter values, measured in real time, a comparison algorithm or table, such as the one-dimensional algorithm charted in FIG. 3, may allow a performance comparison in real time, for example by subtracting the corresponding y-axis performance parameter value on Line B from the corresponding y-axis performance parameter value on Line A.

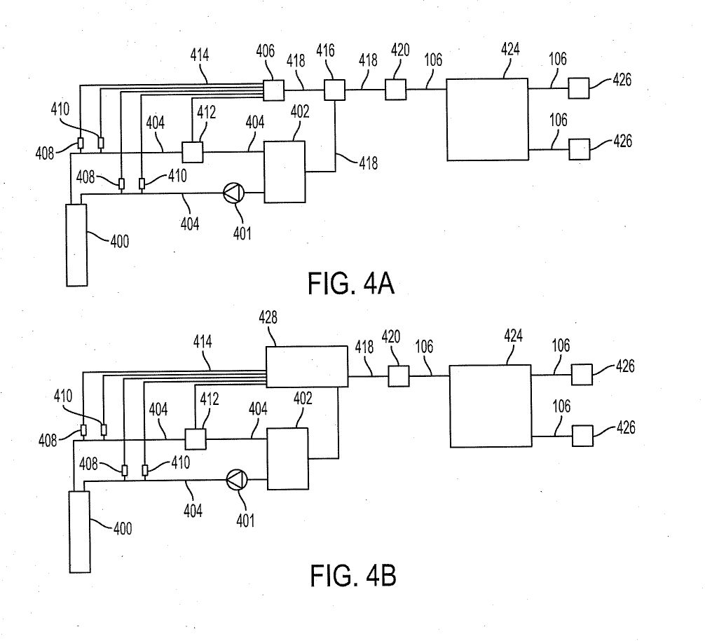

FIG. 4A depicts a renewable energy HVAC system metering and control diagram, according to an embodiment of the present invention. The method of the present invention may be implemented via a software program operating in a client-server environment. The software program may be part of a geothermal HVAC control program or a separate program. The software program may include portions running on the client, the server, or both.

A renewable energy resource 400, for example a geothermal heat exchanger, may be coupled to a circulating pump 401 and existing or new HVAC system equipment 402, often owned by a third party, through heat exchange fluid piping 404. An analog to digital converter device and software control program 406 monitors various temperature sensors 408, pressure sensors 410 and flow rate sensors 412 via analog electrical signal wiring 414. Sensor data, for example a measured value of one or more system parameters, collected by the analog to digital converter device and software control program 406, as well as any data collected by the new or existing HVAC system equipment 402 itself, is sent to a web server device and software control program 416 via digital signal wiring 418. The data may be directed to the web server device and software control program 416 through a firewall, routers and proxy servers, and load balancer. Certificate servers (e.g. web certificate servers and wireless certificate servers) may optionally be deployed on each web server. The web server device 416 may be maintained and operated by the owner of the renewable energy HVAC system or an outside utility provider.

The data is then automatically routed through an Internet router and/or a modem 420 and transmitted via the Internet 106 to a remote and central computer 424, also known as a centralized data repository. The central computer 424 houses software for control and performance comparison of the data collected. The central computer 424 may include high availability storage. The central computer 424 and controlling software may be monitored by an administrator of the renewable energy HVAC metering and control system 100. Such software may constantly analyze the incoming data from the renewable energy HVAC system and may use such data to calculate energy savings in real time, for example by using one-dimensional or multi-dimensional algorithms or tables to compare the expected or actual energy savings of the renewable energy HVAC system with the expected energy savings of a simulated conventional HVAC system.

The central computer 424 may include any type of processor, microprocessor, or processing logic that may interpret and execute instructions (e.g. a field programmable gate array (FPGA)). The processor may comprise a single device (e.g. a single core) and/or a group of devices (e.g. multi-core). The processor may include logic configured to execute computer-executable instructions configured to implement one or more embodiments. The instructions may reside in the memory or ROM and may include instructions associated with the processor.

The memory of the central computer 424 may be a computer readable medium that may be configured to store instructions configured to implement one or more embodiments. The memory may be a primary storage accessible to the processor and may comprise a random-access memory (RAM) that may include RAM devices, such as Dynamic RAM (DRAM) devices, flash memory devices, Static RAM (SRAM) devices, etc.

The ROM of the central computer 424 may include a non-volatile storage that may store information and computer-executable instructions for processor. The computer-executable instructions may include instructions executed by the processor.

The central computer 424 may include a storage device that is configured to store information and instructions for the processor. Examples of a storage device may include a magnetic disk, optical disk, flash drive, etc. The information and computer-executable instructions and information may be stored on a medium contained in the storage device. Examples of media may include a magnetic disk, optical disk, flash memory, etc. The storage device may include a single storage device or multiple storage devices. Moreover, the storage device may attach directly to the computer system of the central computer 424 and/or may be remote with respect to the central computer 424 and connected thereto via a network and/or another type of connection, such as a dedicated link or channel.

The central computer 424 may include an input device including any mechanism or combination of mechanisms that may permit information to be input into the central computer 424, e.g., from a user. The input device may include logic configured to receive information for the computer system from an end user, for example a third party. Third parties may include, for example, building managers, building owners, building occupants, engineers, utility providers and/or external billing services. Examples of an input device may include a keyboard, mouse, touch sensitive display device, microphone, pen-based pointing device, and/or biometric input device, etc.

The central computer 424 may include an output device including any mechanism or combination of mechanisms that may output information from computer system of the central computer 424. The output device may include logic configured to output information from the computer system of the central computer 424. Embodiments of the output device may include user interfaces such as displays, printers, speakers, cathode ray tubes (CRTs), plasma displays, light-emitting diode (LED) displays, liquid crystal displays (LCDs), printers, vacuum florescent displays (VFDs), surface-conduction electron-emitter displays (SEDs), field emission displays (FEDs), etc.

The data repository may include a communication interface having logic configured to interface the computer system of the data repository with the Internet 106 and enable the central computer 424 to exchange information with other entities connected to the Internet 106, such as, for example, service provider, target environment, and cluster, etc. The communication interface may include any transceiver-like mechanism that enables the central computer 424 to communicate with other devices and/or systems, such as a client, a server, a license manager, a vendor, etc. The communications may occur over a communication medium, such as a data network. The communication interface may include one or more interfaces that are connected to the communication medium. The communication medium may be wired or wireless. The communication interface may be implemented as a built-in network adapter, network interface card (NIC), Personal Computer Memory Card International Association (PCMCIA) network card, card bus network adapter, wireless network adapter, Universal Serial Bus (USB) network adapter, modem or any other device suitable for interfacing the central computer 424 to any type of network.

The renewable energy HVAC metering and control system 100 is intended to be accessed by a plurality of clients or users. Such clients may be one or more conventional personal computers and workstations. In FIG. 4A, however, the clients are embodied as Web-enabled, hand-held devices which use the wireless access protocol. Data from the central computer 424 may be transmitted over the Internet 106 to such a receiving device 426, which may allow the user to access a user interface and may allow the user to review the data, energy savings and/or system performance information. The receiving device 426 may provide information to the renewable energy HVAC system itself, or a remote device operated by a party other than the HVAC system or building manager or owner.

According to one embodiment, the results of these calculations and comparisons produced by the central computer 424 may be presented to a user in an easy to understand graphical form, for example a graphical user interface, that is accessible from any receiving device 426, such as a computer or mobile phone that is connected to the Internet.

According to a further embodiment, the user at the receiving device 426 may send a control signal back to the central computer 424 and/or the renewable energy HVAC system. Such a control signal may be based on the energy savings determined by the central computer 424. The control signal may cause the renewable energy HVAC system to adjust an operational mode or functionality of the system to enhance energy savings and/or cooling or heating performance.

FIG. 4B depicts a renewable energy HVAC system metering and control diagram utilizing third-party control, according to a different embodiment of the present invention. Unlike the embodiment of FIG. 4A, data from the temperature sensors 408, pressure sensors 410 and flow rate sensors 412, as well as any data from the new or existing HVAC system equipment 402 itself, is received by a building automation or direct digital control system 428 for use by a third-party with appropriate software. Further, data, for example a measured value of at least one system parameter, may be transmitted from the remote central computer 424 to a receiving device 426, from which an end user may access a user account, and/or an alternative receiving device 430, from which an end user may access an administrator interface.

The renewable energy HVAC metering and control system 100 may use data collected from the analog to digital converter device and software control program 406 and/or the building automation or direct digital control system 428 to provide measurement, calculation, or verification of certain energy-related information, including, but not limited to, energy savings, cost savings, carbon dioxide (CO₂) reductions, etc., using known or later developed correlations. The renewable energy HVAC metering and control system 100 may use the information gathered to aggregate carbon credits produced by the metered renewable energy system or to validate energy or cost savings. To “validate” means to compare the actual operation of a system to a pre-assumed system operation. The primary communication of the resulting reports and control panel is through a website controlled and operated by the administrator of the renewable energy HVAC metering and control system 100.

The renewable energy HVAC metering and control system 100 may provide a building owner, operator and/or manager with control access and may gather, analyze, and use data regarding system performance to actively adjust control parameters to reduce energy consumption. This may be accomplished by integrating Internet-connected building automation systems into the network and metering control systems. Under this system, commands may be sent over the Internet 106 to the building automation system that is capable of controlling various parameters of the renewable HVAC system. The end user may control the entire renewable energy HVAC system, as well as zones or rooms within the system.

The renewable energy HVAC metering and control system 100 may give building owners, operators and/or managers utility-grade information about the use and stability of a renewable energy resource, especially for geothermal heat exchange and other thermal energy systems. The invention may make control of a renewable energy HVAC system accessible to a layperson without requiring advanced knowledge of building automation and control systems.

A user, for example the owner, operator or manager of the building or the administrator of the metering and control system, may be granted access, from any device connected to the Internet 106, to adjust information stored on the remote data repository that can be acted upon in substantially real time by control devices installed within a building to change or improve the functioning of the renewable energy HVAC system. Software designed for such a purpose may also automatically execute a change in device functionality or may automatically suggest that the user execute a change in device functionality to improve system performance. The software may access the remote and central computer 424 and may use data stored from any renewable energy system to identify and execute improvements to any other renewable energy system.

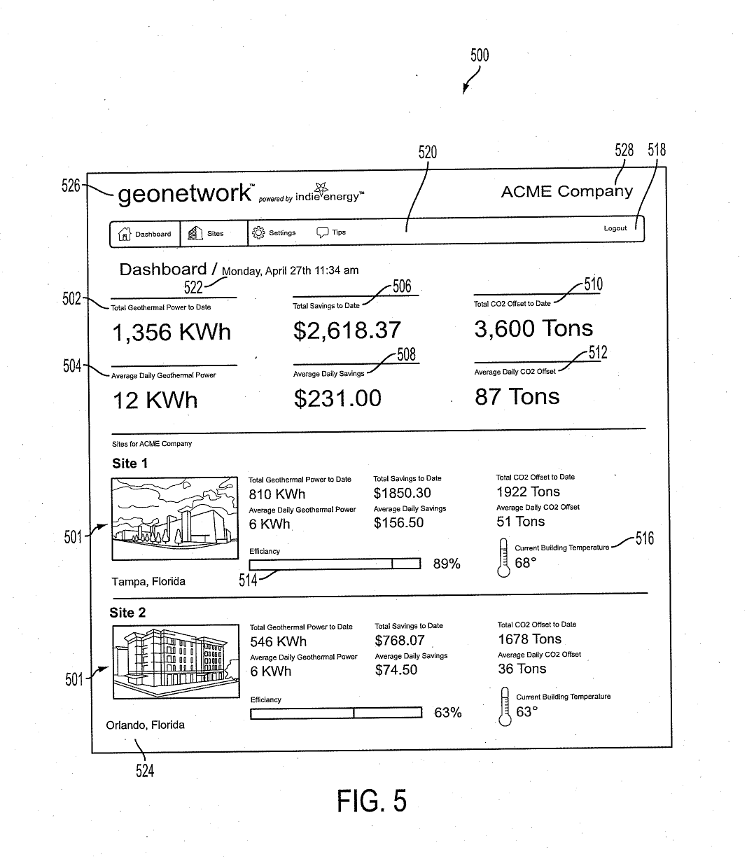

According to one embodiment, energy savings data, dollar savings data and/or aggregated carbon credits generated by the central computer 424 may be displayed at the receiving device 426, 430 via a website owned or maintained by either the HVAC system owner or an outside service company. Embodiments of such a website are shown in FIGS. 5-12B.

For example, FIG. 5 depicts an exemplary “dashboard” screen 500 of the renewable energy HVAC metering and control website accessible by a user over the Internet, according to an embodiment of the present invention. The dashboard screen 500 may be viewed by an end user at an Internet-enabled device 426, 430. The dashboard screen 500 provides the third-party user with an overview of information about all the buildings with renewable energy HVAC systems, in this embodiment a geothermal energy system, it owns or operates. For example, the dashboard screen 500 may display the total geothermal power (kWh) of the system(s) to date 502, as well as the average daily geothermal power 504. The dashboard screen 500 may display the total savings ($) of the geothermal system(s) to date 506, as well as the average daily savings 508. The dashboard screen 500 may also display the total CO₂ offset (Tons) to date 510, as well as the average daily CO₂ offset 512.

If the third-party user or client owns or operates multiple sites that are each equipped with a renewable energy HVAC metering and control system 100, or if the renewable HVAC system includes more than one building or site, a brief overview or summary 501 for each site may be displayed on the dashboard screen 500. For example, in FIG. 5, the dashboard screen 500 displays energy usage, dollar savings and CO₂ offset information for two sites 501, one called “Site 1” and one called Site 2.” The dashboard screen 500 also shows the HVAC system efficiency 514 and the current building temperature 516 for each site. The dashboard screen 500 may further include a Login or Logout status indicator 518, a menu bar 520, the current date and time 522 and site address information 524, as needed. The dashboard screen 500 may indicate the name or trademark 526 of the operator or administrator of the renewable energy HVAC metering and control system 100, for example “geonetwork™ powered by Indie Energy™” and/or the name or trademark of the client 528, for example “Acme Company.”

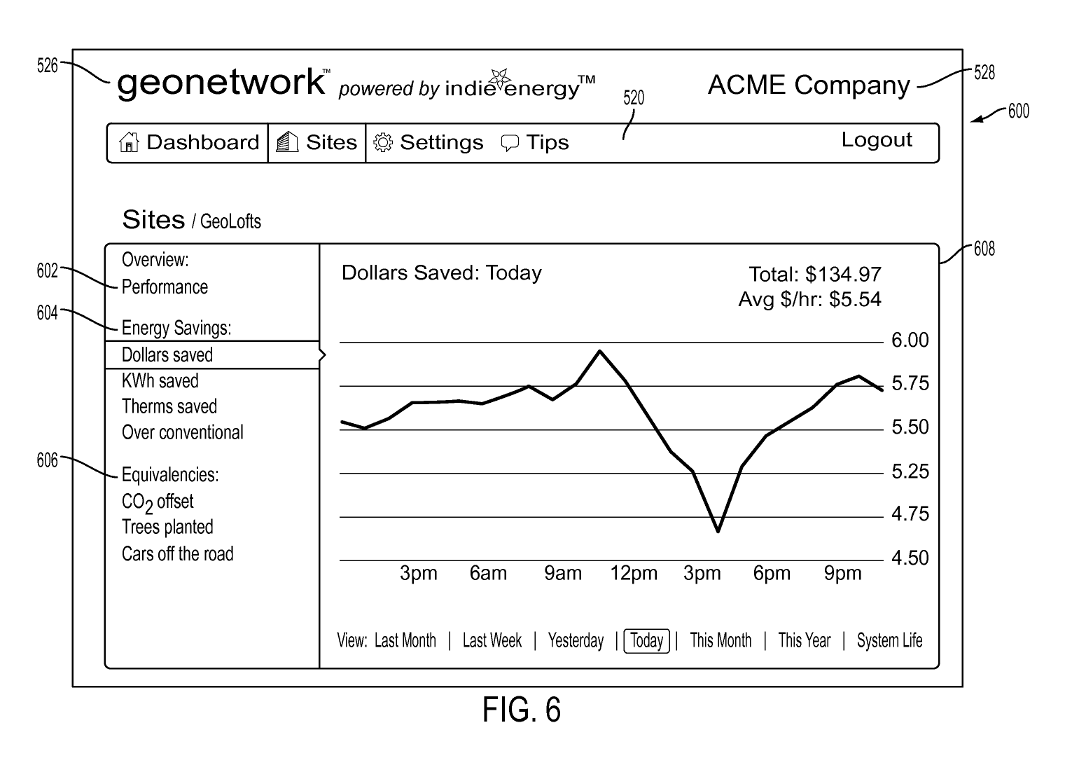

FIG. 6 depicts an exemplary “sites” screen 600 of the renewable energy HVAC metering and control website accessible by a user over the Internet, according to an embodiment of the present invention. The sites screen 600 displays information related to a particular site or location to an end user at an Internet-enabled device 426, 430. For example, such site-related information may include renewable energy HVAC system performance 602, energy savings 604, including, for example, dollars saved, kilo-Watt hours saved, Therms saved and/or a comparison over a conventional HVAC system, and equivalencies 606, including, for example, CO₂ offsets, trees planted or cars off the road.

The embodiment shown in FIG. 6, displays the energy savings 604 of the renewable energy HVAC system using a “Dollars Saved” chart 608. The “Dollars Saved” chart 608 shows the dollars saved over the course of a day, as well as the total dollars saved and the average dollars saved per hour. The “Dollars Saved” chart 608 may show data, for example, for last month, last week, yesterday, today, this month, this year or over the system life.

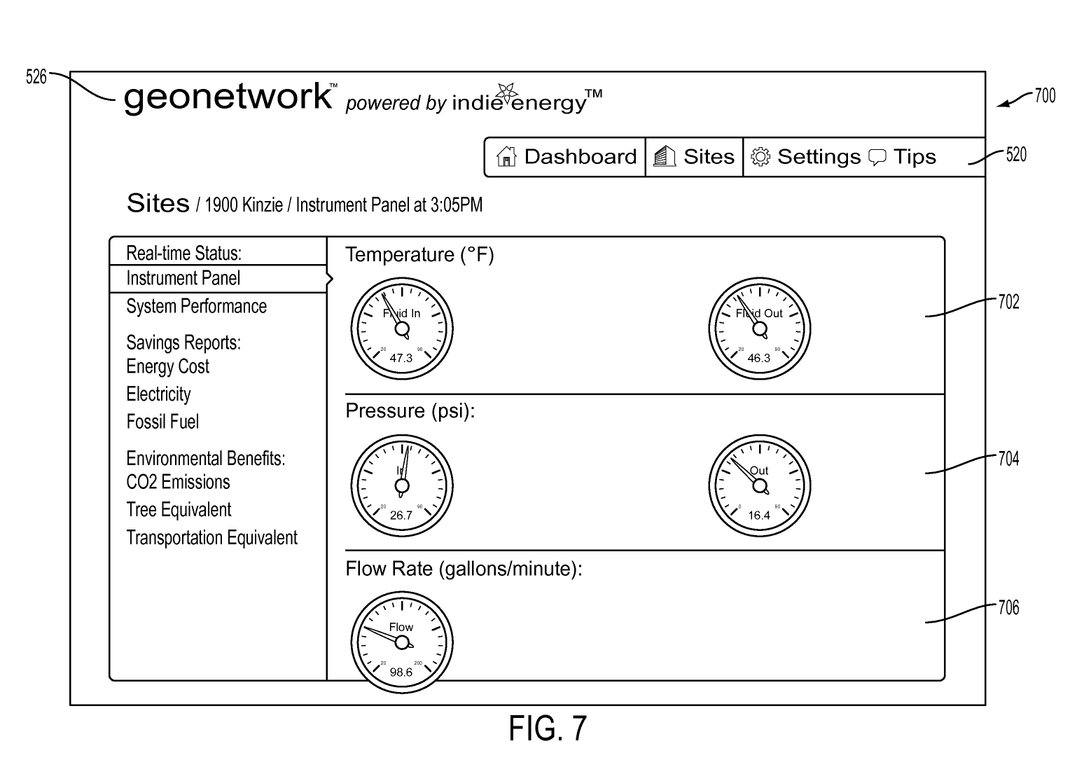

FIG. 7 depicts an “instrument panel” screen 700 of the renewable energy HVAC metering and control website accessible by a user over the Internet, according to an embodiment of the present invention. The instrument panel screen 700 displays real-time status information related to a particular site or location to an end user at an Internet-enabled device 426, 430. Such instrument information may include the temperature (° F.) and pressure (psi) of the fluid out of and the fluid into the renewable energy HVAC system 702, 704, here, for example, a geothermal energy system. The instrument information may further include the flow rate (gallons/min) of the entire renewable energy system 706.

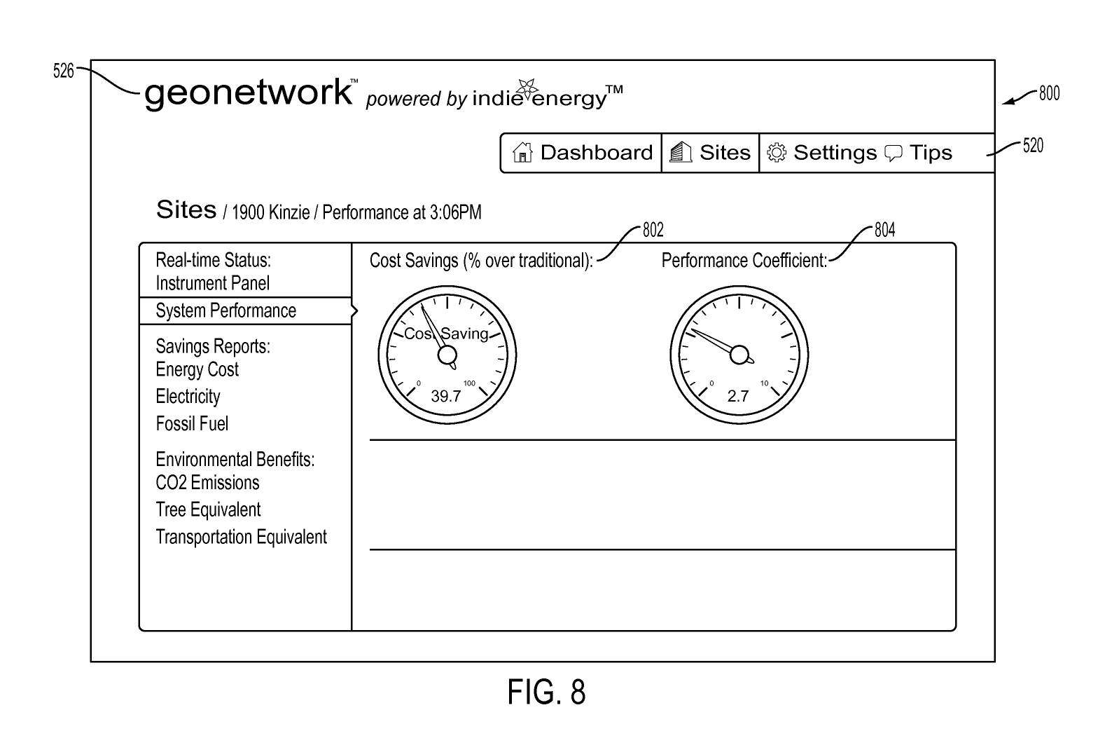

FIG. 8 depicts a “system performance” screen 800 of the renewable energy HVAC metering and control website accessible by a user over the Internet, according to an embodiment of the present invention. The system performance screen 800 may display real-time performance information related to a particular site or location to a third-party user at an Internet-enabled device 426, 430. Such performance information may include the cost savings (%) of the renewable energy HVAC system over a traditional HVAC system 802 and/or a performance coefficient 804.

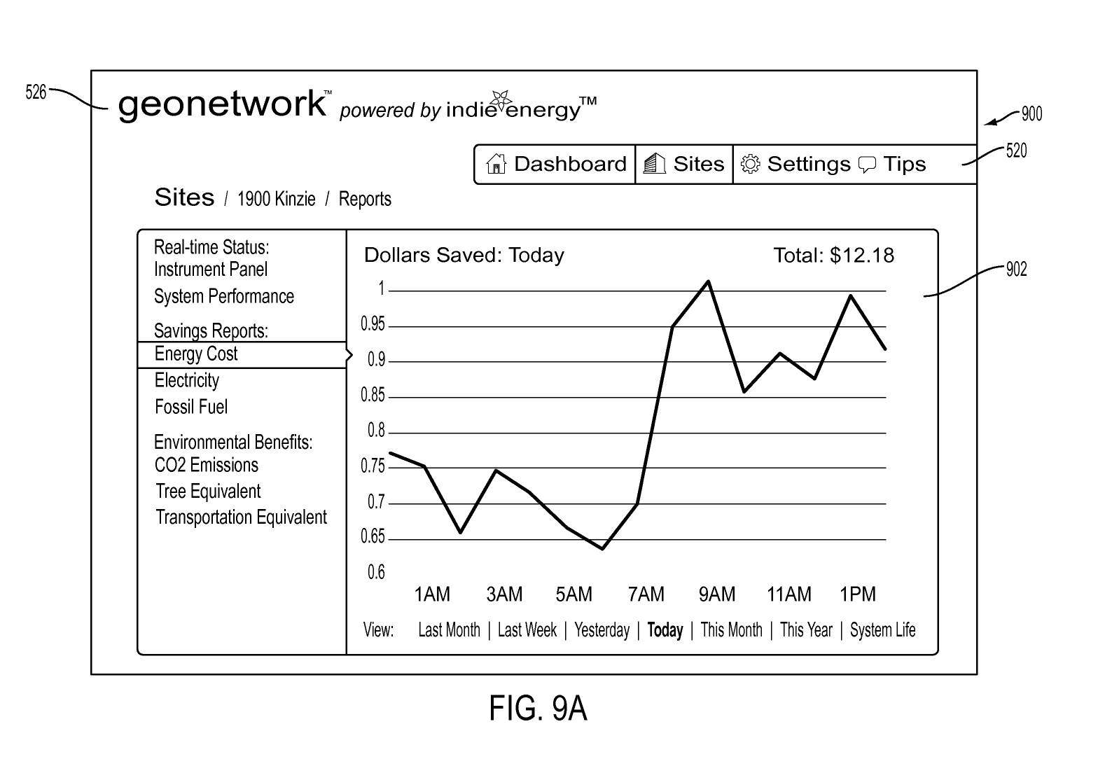

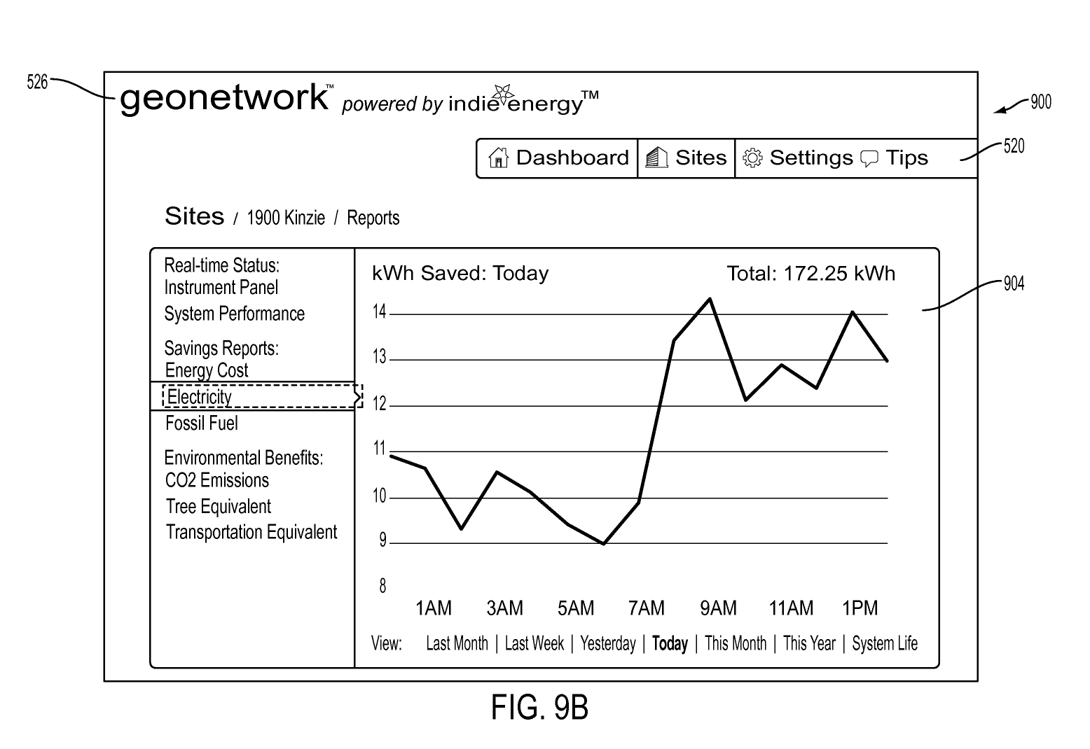

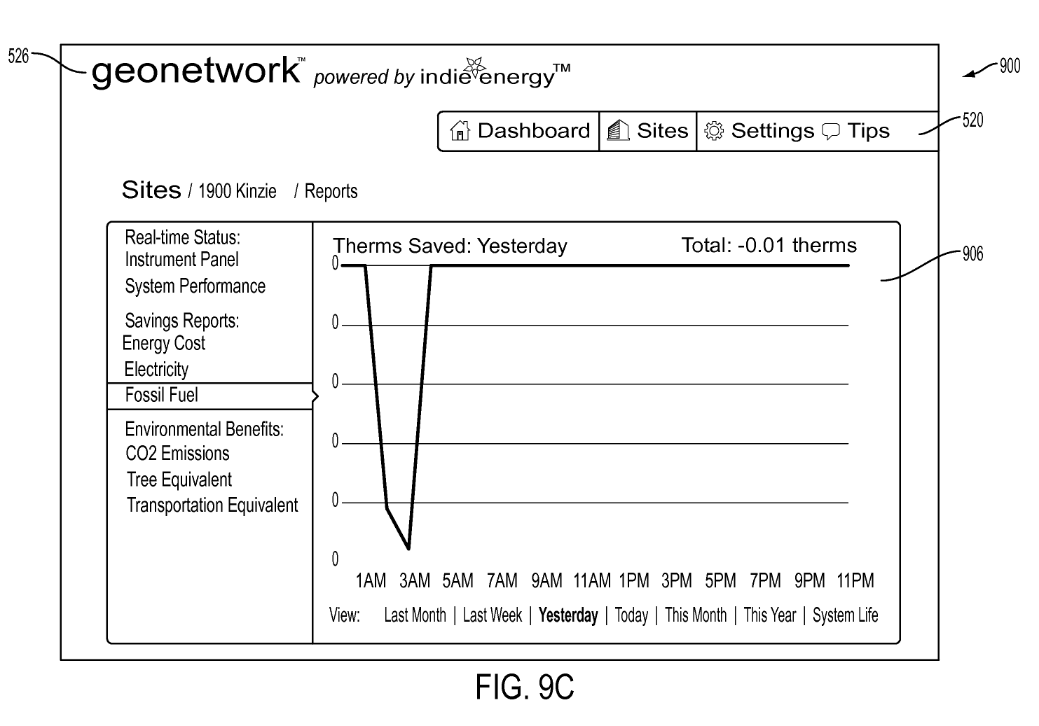

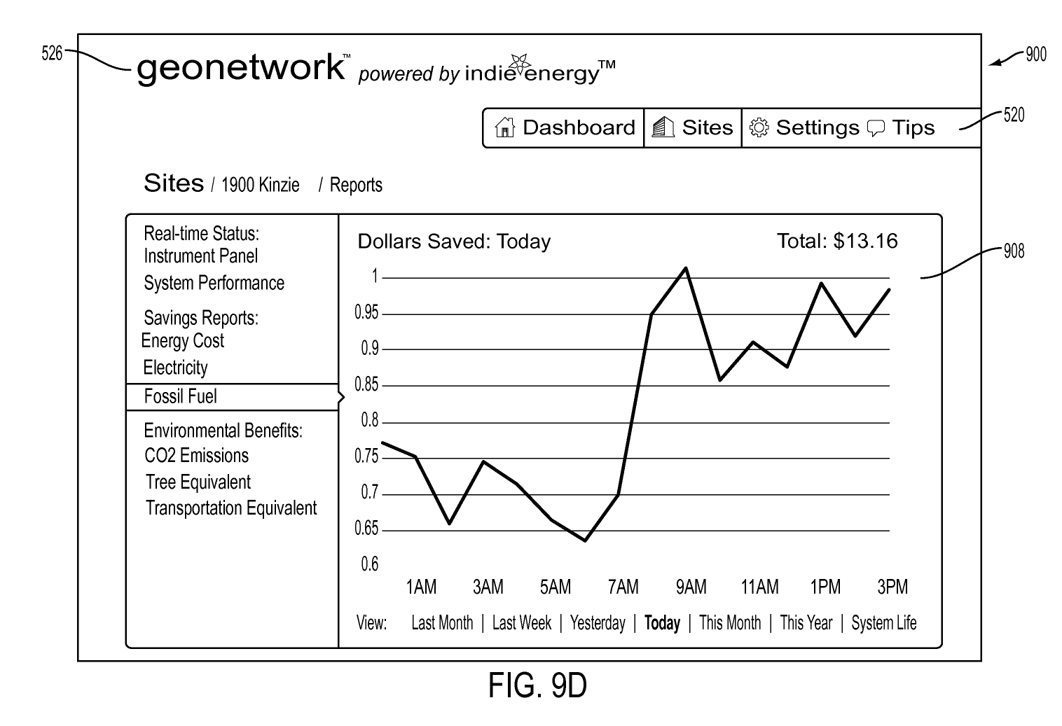

The renewable energy HVAC metering and control system 100 may allow for projections of energy savings produced by the metered renewable energy HVAC systems. According to one embodiment, dollar savings and/or fossil fuel savings may further be determined based on the energy savings processed at the central computer 424. Such information displaying such energy savings, dollar savings and/or fossil fuel savings may be transmitted to the receiving device 426, 430. For example, FIGS. 9A-9D depict “savings report” screens 900 of the renewable energy HVAC metering and control website accessible by a user over the Internet, according to an embodiment of the present invention. The savings report screens 900 may display savings report information related to a particular site or location to an end user at an Internet-enabled device 426, 430. As shown in FIGS. 9A-9C, such savings report information may relate to energy cost based on today's dollars saved 902, electricity savings based on today's kilo-Watt-hours saved 904, or fossil fuel savings based on yesterday's Therms saved 906 and fossil fuel savings based on today's Therms saved 908, respectively. The savings report information may be in the form of charts and/or graphs. The energy cost report may show the cost of energy saved by the renewable energy HVAC system, for example, last month, last week, yesterday, today, this month, this year or over the system life. Similarly, the electricity report may show the energy savings of the renewable energy HVAC system, for example, last month, last week, yesterday, today, this month, this year or over the system life. Further the fossil fuel report may show the Therms (a common unit of energy for natural gas) saved by the renewable energy system, for example, last month, last week, yesterday, today, this month, this year or over the system life. An end-user may manage and control a renewable energy HVAC system using energy savings, cost savings or carbon credits as guidelines.

The renewable energy HVAC metering and control system 100 may allow calculated projections of energy savings produced by the metered renewable energy HVAC systems to be converted to projections of carbon dioxide (CO₂) and other greenhouse gas emissions reductions associated with the use and/or production of conventional energy sources. The conversions are processed on the central computer 424 using publically available metrics for CO₂ and other greenhouse gas emissions associated with the use and/or production of conventional energy sources. The metrics, for example the average mass of CO₂ released to the atmosphere per unit of electricity consumed, may be stored in the memory of the central computer 424 and/or may be automatically retrieved from a third-party, a government agency or utility provider for example, over the Internet 106. The projections of CO₂ greenhouse gas emissions reductions may be displayed in terms of carbon credits according to the common practices of carbon trading markets. The projections of CO₂ greenhouse gas emissions reductions may also be displayed in terms of other commonly practiced activities that have the effect of reducing CO₂ greenhouse gas emissions.

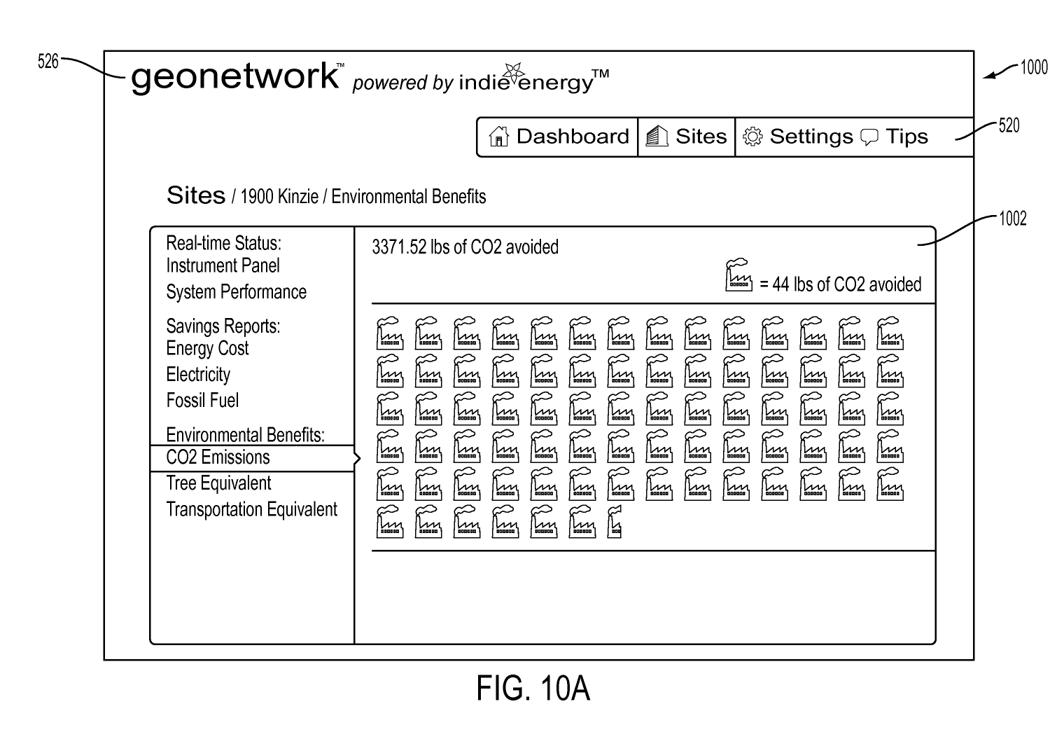

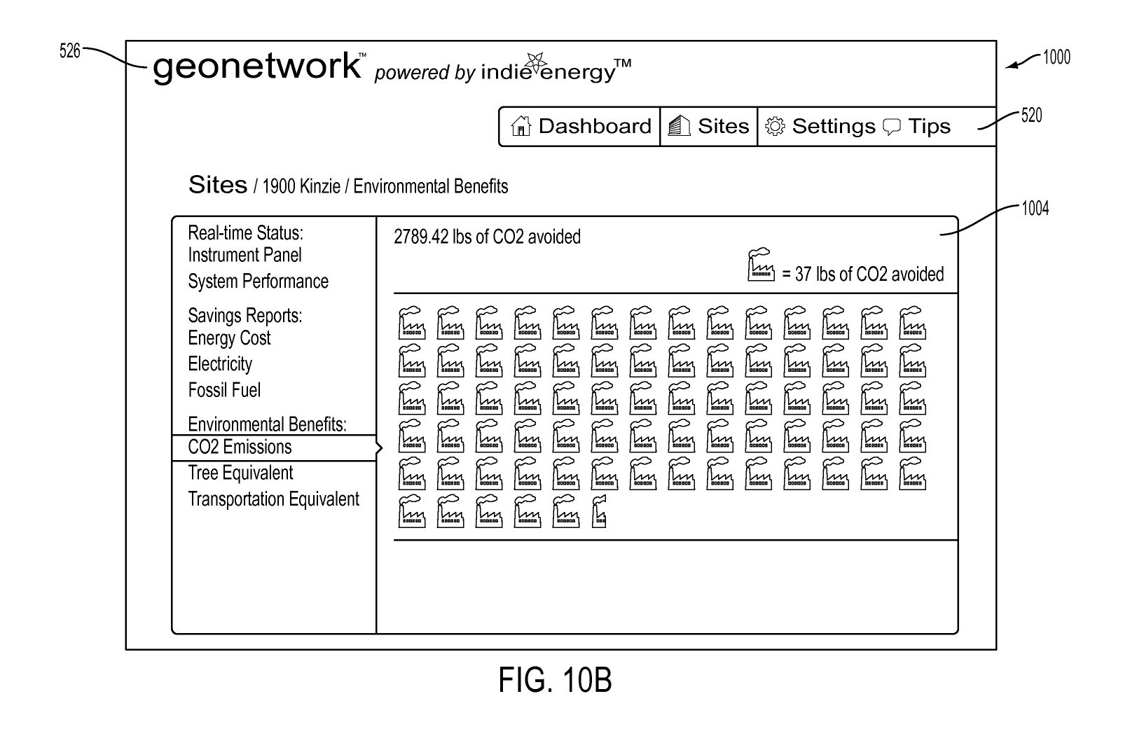

The renewable energy HVAC metering and control system 100 may show end users projections of the aggregation of carbon credits and other equivalent environmental benefits produced by the metered renewable energy HVAC systems. For example, FIGS. 10A-10B depict “CO₂ emissions environmental benefits report” screens 1000 of the renewable energy HVAC metering and control website accessible by a user over the Internet, according to an embodiment of the present invention. The environmental benefits report screens 1000 may display CO₂ emissions information related to a particular site or location to an end user at a receiving device 426, 430. For example, in FIG. 10A, the screen 1000 may graphically display the number of pounds of CO₂ avoided over the time period of a month due to the use of the renewable energy HVAC system 1002. In FIG. 10B, the screen 1000 displays the number of pounds of CO₂ avoided over a week 1004. An end user may use carbon credits as a guideline for managing and controlling a renewable energy HVAC system.

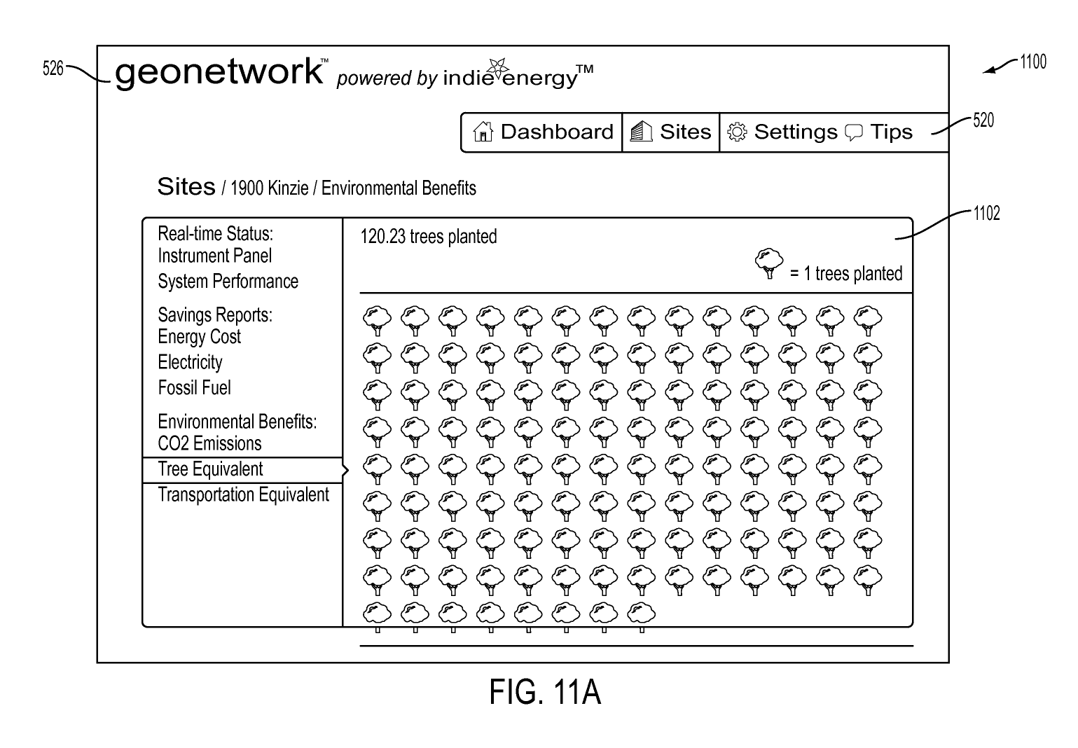

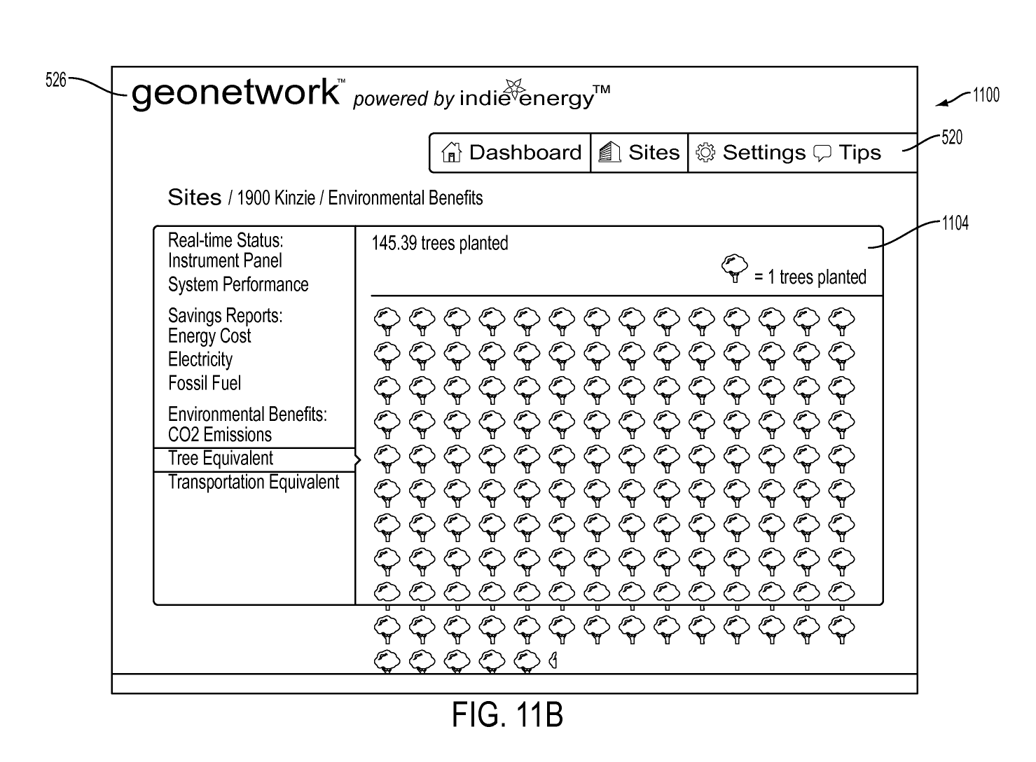

FIGS. 11A-11B depict “planted-tree equivalent environmental benefits report” screens 1100 of the renewable energy HVAC metering and control website accessible by a user over the Internet, according to an embodiment of the present invention. The environmental benefits report screens 1100 may display tree equivalent information related to a particular site or location to an end user at an Internet-enabled device 426, 430. For example, in FIG. 11A, the screen 1100 may graphically display the number of trees planted over a week as an equivalent to the amount of CO₂ avoided by the renewable energy HVAC system 1102. In FIG. 11B, the screen 1100 displays the equivalent number of trees planted over a month 1104.

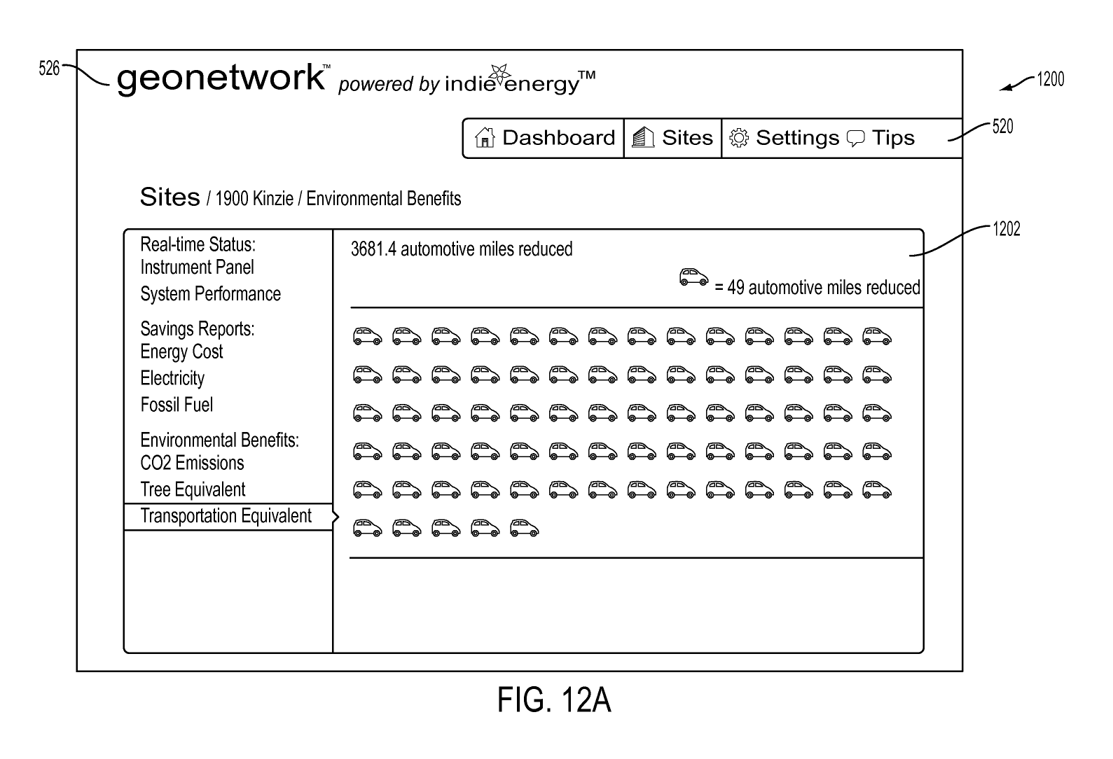

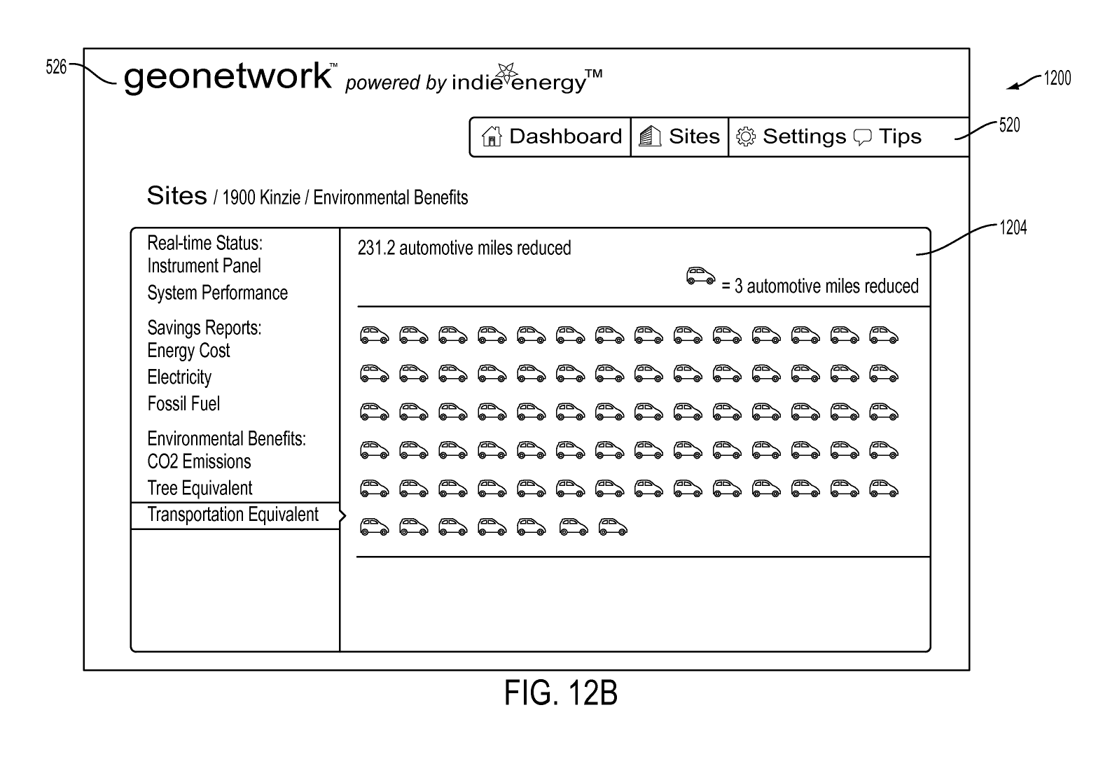

FIGS. 12A-12B depict “transportation equivalent environmental benefits report” screens 1200 of the renewable energy HVAC metering and control website accessible by a user over the Internet, according to an embodiment of the present invention. The environmental benefits report screens 1200 may display transportation equivalent information related to a particular site or location to an end user at an Internet-enabled device 426, 430. For example, in FIG. 12A, the screen 1200 graphically displays the number of automotive miles reduced over a system's life, as an equivalent of the CO₂ avoided by the renewable energy HVAC system 1201. In FIG. 12B, the screen 1200 displays the number of automotive miles reduced on a single day 1204. Again, these reports may each be generated in various increments of time, for example, last month, last week, yesterday, today, this month, this year or over the system life.

According to one embodiment, the renewable energy HVAC metering and control system 100 may use at least one exemplary metered parameter of a geothermal heat exchange or other renewable energy HVAC system to communicate with a third party for purposes of determining the optimal system settings for best performance. Examples of metered parameters may include energy field fluid temperature, flow rate, pressure, etc. Information relating to the metered parameter may be broadcast either by electronic communication or via the Internet packets of data measured at the building to a remote server. The system may also receive and implement information received from a third party regarding control algorithms for a renewable energy HVAC system. The renewable energy HVAC metering and control system 100 may automatically improve the system performance based on data gathered and analyzed by a third party.

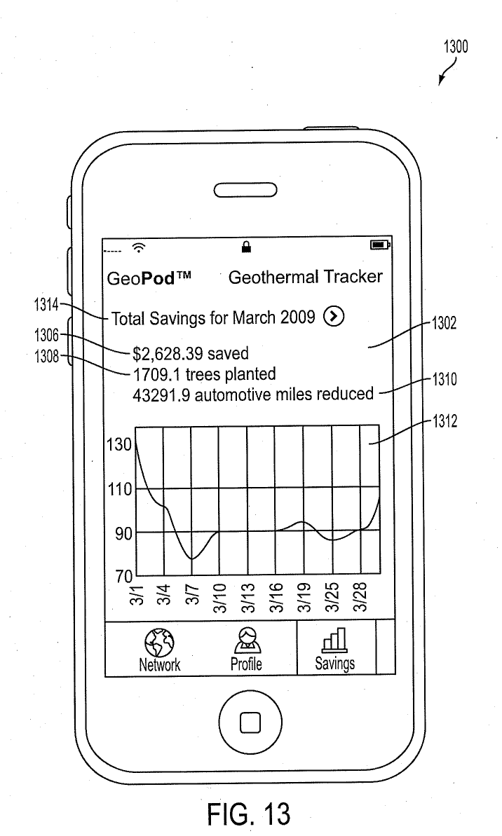

For example, the renewable energy HVAC metering and control system 100 may provide a device to transmit, receive and implement control commands from a remote location using a third party mobile device for purposes of remote control of a renewable energy HVAC system by a third party user, who may be a building owner, operator or manager. According to one embodiment, software may allow the third party user to access and change system control parameters from a mobile device. For example, data from the renewable energy HVAC metering and control system 100 may be viewable on a Smart Phone or hand-held Internet-enabled device (See FIG. 13). Thus, a third-party user may monitor and control the renewable energy HVAC system from anywhere in the world at any given time.

FIG. 13 depicts a hand-held Internet-enabled device 1300 for viewing system-related information, according to one embodiment of the present invention. The Internet-enabled device 1300 may comprise a Blackberry®, IPhone®, IPad® or other hand-held device. The hand-held Internet-enabled device 1300 includes a screen 1302, which allows a third-party user to upload information from the renewable energy HVAC metering and control system website. For example, as shown in FIG. 13, a user may view the total savings of a geothermal HVAC system over a month 1304, including the dollar amount saved 1306, the equivalent number of trees planted 1308 and/or the equivalent number of automotive miles reduced 1310. The hand-held Internet-enabled device 1300 may further present such information in an easy-to-understand graph, image or chart 1312. This application allows a third-party user to access system-related information anywhere and at any time.

According to one embodiment, a third party user may transmit a control signal or system instructions back to the renewable energy HVAC system. Such a control signal may be based on a measured system parameter, for example room temperature or flow rate, or the user's preference of the HVAC system's energy usage, dollar savings and/or carbon credits. The third party user may control all or part of the renewable energy HVAC system. For example, the third party user may prefer to keep a certain section of a building cooler than another section and may adjust the parameters of the system accordingly.

In one embodiment, third-party sensor devices, third-party control devices, and third-party web server devices may be added to, modified, or installed as part of a new third-party building automation or direct digital control system (an Automated Logic Corporation system, for example) in order to meter a renewable energy HVAC system according to the methods described herein. A device or a computer code may be used to transmit data over the Internet between the third-party building automation or direct digital control system and the remote and centralized data repository in order to utilize functions and methodologies for performance comparisons, renewable energy control, user interfaces, and other analysis and control functions described herein. A user interface created by a third party may access the remote and centralized data repository in order to incorporate, analyze, display, or in other ways use data or the results of calculations from the remote and centralized data repository.

According to another embodiment, the renewable energy HVAC metering and control system 100 may provide the information and means to a third party or a virtual utility for assessing and billing for utility use. In one embodiment, renewable energy resource 212 transfers energy 210 to one conditioned building 200, or multiple conditioned buildings, in which two or more tenants share the cost of using the renewable energy resource 212. The renewable energy HVAC metering and control system 100 may calculate the cost associated with each tenant according to actual or expected renewable energy use.

Further details of the renewable energy HVAC metering and control system 100 are provided as follows:

Computer Simulation: Any accepted methodology and tool-set may be used to model and create computer simulations for the energy consumption of the building that will use the renewable energy HVAC system. For example, the tool set may be based upon the Transient Energy System Simulation Tool (TRNSYS) software program and may include templates and data reference files designed by those of ordinary skill in the art. When sufficient energy data exists for a building operating before or after a renewable energy retrofit, the computer simulations may be calibrated based on actual data to minimize error. Otherwise, experience-based measures and assumptions may be used to build the equivalent conventional model. The analysis methodology conforms to, but is not limited to, industry-accepted guidelines for energy analysis and comparison.

Measurement of Actual Performance of an Example Geothermal HVAC System: In one embodiment, the rate of heat transfer across a closed-loop geothermal heat exchanger may be measured using the heat exchange fluid flow rate, temperature into the heat exchanger, temperature out of the heat exchanger, pressure into the heat exchanger, and pressure out of the heat exchanger. The rate of geothermal heat transfer may be calculated from these values using an energy conservation method.

An electromagnetic flow rate sensor may be used to measure the flow rate of the heat exchange fluid. This instrument may increase accuracy and reduce installation costs by eliminating calibration. An ultrasonic flow rate sensor may provide similar functionality. The sensor output may be an analog or digital electrical signal. The flow rate sensor may be located in-line with the process piping to or from the geothermal heat exchanger.

Fluid temperature may be measured by thermocouple or resistance temperature detector sensors. The output of these sensors may be an analog or digital electrical signal. The temperature sensors may be located in process piping to and from the geothermal heat exchanger.

The fluid pressure may be measured with a pressure transducer. The output of these sensors may be an analog or digital electrical signal. The pressure sensors may be located in process piping to and from the geothermal heat exchanger.

Operational data communicated from other sensors, HVAC equipment, existing building automation or direct digital control systems, weather stations, utilities, or other relevant sources may be transmitted to or converted for use in the renewable energy monitoring and control system.

Device Communication and Control Network: A communication and control network may be installed or adapted for the purposes of communicating information about the operation of renewable energy systems within a building or buildings. For example, all metering and control devices may communicate over a protocol recognized by ISO/IEC, ANSI/EIA, SEMI, and IEEE. The communication protocol may be able to function over multiple mediums, including power line, unshielded twisted pair, radio frequency, infared, coaxial cable, and fiber optics. Devices connected within the communication network may be interoperable with devices from different manufacturers without a gateway device to translate data from one device to another. Devices connected within the communication network may be capable of passing information through Internet connectivity devices via standard web services, such as HTTP, XML, or SOAP.

In some embodiments, where the description above refers to the internet, a local area network may be used instead. Thus, some or all of the metering and control data described above may be transferred within a closed system, under control of a single user, with only particular data, or none at all, transferred through the internet.

According to an embodiment, the communication system may include defenses against unauthorized system use. A multi-tiered permission user account system may limit access from unauthorized parties.

Example Geothermal Power Calculations: For a real building with an installed geothermal heat pump system, this methodology may allow for accurate estimations of energy consumption based on the rate of geothermal heat transfer and/or other system parameters. The estimations can be simultaneously calculated for two or more system variations, for example a conventional HVAC system and a geothermal HVAC system, based on parameters derived from computer simulations of each variation. By comparing these estimations, the energy savings (or cost, carbon, or other correlated benefits) of a geothermal heat exchanger or other energy saving technology can be calculated in substantially real time.

A set of polynomial functions and/or a set of reference tables may define the relationship between the measurable system parameters (including geothermal heat transfer) and the estimated energy consumption for each system variation. The parameters of these functions and/or reference tables may be derived from computer simulation.

Renewable energy systems. In an embodiment where a solar collector is the renewable energy source, temperature, pressure, and fluid flow rate sensors may be used to meter the solar thermal energy resource in similar method to the geothermal energy resource metering method described herein. In an embodiment where wind energy is the renewable energy source, temperature, pressure, and wind speed sensors may be used to meter the wind energy resource in similar method to the geothermal energy resource metering method described herein.

Advanced controls. In some embodiments, the measured parameters include heating and cooling loads from different zones within a building, such as different rooms. For example, with a geothermal system, the control system of the invention may shift heating and cooling loads from zone to zone within the building, reducing the overall energy cost. For example, even in the heating season, a computer server room may need to be cooled, and the heat removed from that zone may be moved via a geothermal heat transfer system to another zone requiring heating.

Web Services: Signals from each of the sensors within a building may be read by a computer processor device. The computer processor may enable conversions from analog or digital electrical signals to useful data types. The computer processor can implement control algorithms and communicate with other computer processor devices within the building or at a remote location.

The primary storage medium for the building data may be a remote and centralized web server, running database software designed by the system administrator. The remote database software may execute performance calculations and equivalency calculations in substantially real time.

Performance calculations may include projections of energy consumption required to meet the instantaneous space conditioning and/or utility demands of the building. Performance calculations may include comparisons between an installed renewable energy HVAC system and a conventional HVAC system alternative. Performance calculations may also include instantaneous performance coefficients such as the amount of useful heat transfer divided by the electrical energy input.

The theoretical performance of the renewable resource energy system may be calculated in substantially real time. The renewable energy system performance calculations may take relevant renewable energy system measurements as inputs to performance functions. Performance functions may be based upon, and substantially defined by, the results of computer energy simulations.

The theoretical performance of a conventional energy system alternative (also known as budget system) may also be calculated in substantially real time. Where applicable, the conventional energy system alternative may be simulated according to established HVAC industry guidelines such as the American Society of Heating, Refrigeration and Air-Conditioning Engineers (ASHRAE) Standard 90.1, the International Performance Measurement and Verification Protocol (IPMVP), or the U.S. Department of Energy's Federal Energy Management Program (FEMP). The conventional energy system performance calculations may take relevant renewable energy system measurements as inputs to performance functions. Performance functions may be based upon, and substantially defined by, the results of computer energy simulations.

The computer energy simulations that define performance relationships for both the renewable energy system and the conventional energy system alternative may be performed using a simulation tool with mathematical calculation methodologies designed to model the specific components of the renewable energy system being measured. The simulation environment may be capable of time-steps of less than 10 minutes, and may be capable of trending system parameters for each time-step that directly represent real and measurable information from an installed renewable energy system.

The computer energy simulation environment may meet standards defined by ASHRAE Standard 140. The system simulations may be capable of being calibrated to data measured directly from the renewable energy system installation according to guidelines defined by IPMVP Option D: Calibrated Simulation. Calibration may include the use of multi-parameter numerical optimization algorithms.

The database software may also implement control algorithms and send control signals back to the computer processor device. This can be accomplished by communications over the Internet between the database software (or a mobile device used in conjunction with the database software) and a device, such as a building automation or direct digital control system, that controls aspects of the alternative energy HVAC system.

Another function of the database software may be to provide user interest information to the end user. The database may generate and store trend information regarding the energy performance of the building. A web interface may offer an aesthetically pleasing and intuitive user experience.

When unique data is captured for more than one tenant-occupied building space, the database software may allow separate calculations of energy use for the purposes of tenant billing.

Equivalencies: Once energy consumption estimates have been generated for a building or a set of building variations, the energy values may be translated to familiar terms for the end user. These terms include, but are not limited to, units of energy for electricity and natural gas, cost in dollars, and emissions from the generation of energy. The emissions information, especially units of carbon dioxide, may be stored for use in the carbon credit market. The calculations may allow estimates of carbon used as well as carbon avoided through the implementation of a renewable energy technology.

Conversion factors from government agencies and other credible external sources may be used to compute these user-interest equivalencies. These conversion factors may be periodically updated. Equivalency calculations may be executed in substantially real time and stored in a database, such that changes in conversion factors and energy prices do not distort historical trend data.

It will be understood that the above description of the present invention is susceptible to various modifications, changes and adaptations, and that the same are intended to be comprehended within the meaning and range of equivalents of the appended claims.

What is claimed is:

1. A method for metering a renewable energy HVAC system, comprising the steps of:
receiving a measured value of a parameter of the renewable energy HVAC system at a central computer;
determining an energy usage of the renewable energy HVAC system with the central computer based on the measured value;
estimating an energy usage of a simulated conventional HVAC system with the central computer based on the measured value;
determining an energy savings of the renewable energy HVAC system with the central computer by comparing the determined energy usage of the renewable energy HVAC system to the estimated energy usage of the simulated conventional HVAC system; and
transmitting the energy savings to a receiving device.

2. The method of claim 1, wherein the receiving device is located at the central computer or the renewable energy HVAC system, or is a remote device.

3. The method of claim 1, wherein the step of determining an energy savings includes utilizing at least one of a set of polynomial functions, a set of one-dimensional or multi-dimensional algorithms or a set of reference tables to define a relationship between the measured value of the parameter of the renewable energy HVAC system and the determined or estimated energy usage.

4. The method of claim 1, wherein the step of transmitting the energy savings comprises transmitting the energy savings over a network to a remote device having a graphical user interface.

5. The method of claim 1, further comprising the steps of:
determining CO₂ emission reductions or cost savings based on the energy savings at the central computer; and
transmitting the CO₂ emission reductions or the cost savings to the receiving device.

6. The method of claim 5, further comprising the steps of:
aggregating carbon credits based on the determined CO₂ emission reductions at the central computer; and
transmitting the aggregated carbon credits to the receiving device.

7. The method of claim 1, further comprising the steps of:
metering the parameter at the renewable energy HVAC system; and
transmitting the measured value of the parameter to the central computer.

8. The method of claim 7, further comprising the steps of:
receiving a control signal at the renewable energy HVAC system from the receiving device; and
adjusting an operational mode of the renewable energy HVAC system based on the control signal to change the energy savings of the renewable energy HVAC system.

9. The method of claim 1, wherein the renewable energy HVAC system comprises a geothermal heat exchange system.

10. A non-transitory computer readable medium storing computer readable program code for causing a computer to perform the steps of:
receiving a measured value of a parameter of a renewable energy HVAC system;
determining an energy usage of the renewable energy HVAC system based on the measured value;
estimating an energy usage of a simulated conventional HVAC system based on the measured value; and
determining an energy savings of the renewable energy HVAC system by comparing the determined energy usage of the renewable energy HVAC system to the estimated energy usage of the simulated conventional HVAC system.

11. The non-transitory computer readable medium of claim 10 storing computer readable program code for causing a computer to perform the further step of:
determining CO₂ emission reductions or cost savings based on the energy savings.

12. The non-transitory computer readable medium of claim 11 storing computer readable program code for causing a computer to perform the further step of: aggregating carbon credits based on the determined CO₂ emission reductions.

13. The non-transitory computer readable medium of claim 10 storing computer readable program code for causing a computer to perform the further step of: determining the energy savings using at least one of a set of polynomial functions, a set of one-dimensional or multi-dimensional algorithms or a set of reference tables to define a relationship between the measured value of the parameter of the renewable energy HVAC system and the determined or estimated energy usage.

14. The non-transitory computer readable medium of claim 10 storing computer readable program code for causing a computer to perform the further step of: metering the parameter at the renewable energy HVAC system.

15. The non-transitory computer readable medium of claim 14 storing computer readable program code for causing a computer to perform the further steps of:
receiving a control signal at the renewable energy HVAC system from the receiving device; and
adjusting an operational mode of the renewable energy HVAC system based on the control signal to change the energy savings of the renewable energy HVAC system.

16. A central renewable energy HVAC metering and control system, comprising:
a central receiver to receive a measured value of a parameter of a renewable energy HVAC system;
a first processing device configured to receive the measured value from the receiving device and to determine an energy usage of the renewable energy HVAC system based on the measured value and to estimate an energy usage of a conventional HVAC system based on the measured value;
a second processing device coupled to the first processing device to calculate an energy savings of the renewable energy HVAC system by comparing the determined energy usage of the renewable energy HVAC system to the estimated energy usage of the simulated conventional HVAC system; and
a transmitting device configured to receive the energy savings from the second processing device and to transmit the energy savings to a receiving device.

17. The central renewable energy HVAC metering and control system of claim 16, wherein the receiving device is located at the renewable energy HVAC system, or is one of the central receiver or a remote device.

18. The central renewable energy HVAC metering and control system of claim 16,
wherein the first processing device further determines CO₂ emission reductions or cost savings based on the energy savings at the second processing device, and
wherein the transmitting device further transmits the CO₂ emission reductions or the cost savings to the receiving device.

19. The central renewable energy HVAC metering and control system of claim 18, further comprising: a third processing device coupled to the first processing device to aggregate carbon credits based on the determined CO₂ emission reductions, wherein the transmitting device is configured to receive the aggregated carbon credits from the third processing device and transmits the aggregated carbon credits to the receiving device.

20. The central renewable energy HVAC metering and control system of claim 16, further comprising:
a metering device at the renewable energy HVAC system to monitor the parameter; and
a transmitter coupled to the metering device to transmit the measured value of the parameter to the central receiver.

21. The central renewable energy HVAC metering and control system of claim 20, further comprising:
a control receiver at the renewable HVAC system to receive a control signal from the receiving device; and
an adjusting device configured to receive the control signal from the control receiver and to adjust an operational mode of the renewable energy HVAC system based on the control signal to change the energy savings of the renewable energy HVAC system.

22. The central renewable energy HVAC metering and control system of claim 16, wherein the renewable energy HVAC system comprises a geothermal heat exchange system.
